(19) United States
(12) Patent Application Publication
(10) Pub. No.: US 2024/0037408 A1
(43) Pub. Date: Feb. 1, 2024

(54) METHOD AND APPARATUS FOR MODEL TRAINING AND DATA ENHANCEMENT, ELECTRONIC DEVICE AND STORAGE MEDIUM

(71) Applicant: JINGDONG CITY (BEIJING) DIGITS TECHNOLOGY CO., LTD., Beijing (CN)

(72) Inventors: Xinzuo WANG, Beijing (CN); Yang LIU, Beijing (CN); Junbo ZHANG, Beijing (CN); Yu ZHENG, Beijing (CN)

(73) Assignee: JINGDONG CITY (BEIJING) DIGITS TECHNOLOGY CO., LTD., Beijing (CN)

(21) Appl. No.: 18/254,158

(22) PCT Filed: Nov. 15, 2021
(86) PCT No.: PCT/CN2021/130667

§ 371 Date: May 23, 2023

(30) Foreign Application Priority Data
Nov. 23, 2020 (CN) 202011320953.8

(51) Int. Cl. G06N 3/094; G06N 3/045

(52) U.S. Cl. CPC G06N 3/094; G06N 3/045

(57) ABSTRACT

Disclosed are a method and an apparatus for model training and data enhancement, an electronic device and a storage medium. A generative adversarial network model includes a generator and two discriminators, an output of the generator is used as an input of the two discriminators, the method including: generating, by the generator, reference sample data; calculating, by the first discriminator, a first distance between the reference sample data and preset negative sample data; calculating, by the second discriminator, a second distance between negative class data composed of the reference sample data and the preset negative sample data and preset positive sample data; determining an objective function based on the first distance and the second distance; and training the generative adversarial network model by using the objective function until the generative adversarial network model converges, to obtain the generative adversarial network model.

### CROSS-REFERENCE TO RELATED APPLICATIONS

This application is the National Stage of International Application No. PCT/CN2021/130667, filed on Nov. 15, 2021, which claims priority to Chinese Patent Application No. 202011320953.8, entitled “METHOD AND APPARATUS FOR MODEL TRAINING AND DATA ENHANCEMENT, ELECTRONIC DEVICE AND STORAGE MEDIUM” and filed with China National Intellectual Property Administration on Nov. 23, 2020, all contents of which are incorporated herein by reference.

### TECHNICAL FIELD

The present application generally relates to the technical field of computers, and more particularly to a method and an apparatus for model training and data enhancement, an electronic device and a storage medium.

### BACKGROUND

With the continuous progress of data collection technology, more and more data are being collected and widely used in business analysis, financial services, medical education and other aspects.

However, due to the imbalance of data itself and the limitation of collection methods, quite a considerable amount of data has no labels or unbalanced labels. Unbalanced labels of data samples mean that among the data sources with different labels, the data of some labels account for the vast majority, while the data of other labels only account for a small part. For example, in the binary prediction problem, the data labeled “1” accounts for 99% of the total, while the data labeled “0” only accounts for 1%.

### SUMMARY

In a first aspect, the present application relates to a method for model training, where a generative adversarial network model includes a generator and two discriminators, an output of the generator is used as an input of the two discriminators, the method including:

generating, by the generator, reference sample data;

calculating, by the first discriminator, a first distance between the reference sample data and preset negative sample data;

calculating, by the second discriminator, a second distance between negative class data composed of the reference sample data and the preset negative sample data and preset positive sample data;

determining an objective function based on the first distance and the second distance; and

training the generative adversarial network model by using the objective function until the generative adversarial network model converges, to obtain the generative adversarial network model.

In some embodiments, an optimization objective of the objective function is to minimize the first distance and maximize the second distance.

In some embodiments, training the generative adversarial network model by using the objective function until the generative adversarial network model converges, to obtain the generative adversarial network model includes:

training the generative adversarial network model by using the objective function to obtain generator parameters of the generator, first discriminator parameters of the first discriminator and second discriminator parameters of the second discriminator; and

inputting the generator parameters, the first discriminator parameters and the second discriminator parameters into the generative adversarial network model to obtain the generated countermeasure network model.

In some embodiments, the objective function is:

$${min}_{G} {max}_{{D}_{1} , {D}_{2}} V ( {D}_{1} , {D}_{2} , G ) \\ V ( {D}_{1} , {D}_{2} , G ) = {E}_{x ∼ {p}_{negData}} [ log {D}_{1} ( x ) ] + {E}_{Z ∼ {p}_{Z}} [ log {D}_{1} ( z ) ] + {E}_{x ∼ {p}_{posData}} [ log {D}_{2} ( x ) ] + {E}_{y ∼ {p}_{allData}} [ log ( 1 - {D}_{2} ( y ) ) ]$$

wherein, posData represents positive class data, negData represents negative class data, allData represents a union of generated negative class data and original negative class data, D₁ represents a first discriminator parameter, D₂ represents a second discriminator parameter, G represents a generator parameter.

In some embodiments, the structure of the first discriminator and the structure of the second discriminator are the same, the first discriminator includes a plurality of cascaded discriminant units and sigmoid layers, the output of the last discriminant unit serves as an input to the sigmoid layer, and each of the discriminant units includes cascaded fully connected layer, leaky-ReLU layer and sigmoid layer.

In a second aspect, the present application relates to a method for data enhancement, including:

generating second negative sample data by using a generative adversarial network model, where the generative adversarial network model is trained by using a method for model training according to the first aspect; and

adding the second negative sample data to an original data set to obtain a new data set, where the original data set includes preset positive sample data and preset negative sample data.

In a third aspect, the present application relates to an apparatus for model training, where a generative adversarial network model includes a generator and two discriminators, an output of the generator is used as an input of the two discriminators, the apparatus including:

a generation module, configured for generating, by the generator, reference sample data;

a first calculation module, configured for calculating, by the first discriminator, a first distance between the reference sample data and preset negative sample data;

a second calculation module, configured for calculating, by the second discriminator, a second distance between negative class data composed of the reference sample data and the preset negative sample data and preset positive sample data;

a selection module, configured for determining an objective function based on the first distance and the second distance; and

a training module, configured for training the generative adversarial network model by using the objective function until the generative adversarial network model converges, to obtain the generative adversarial network model.

In some embodiments, an optimization objective of the objective function is to minimize the first distance and maximize the second distance.

In some embodiments, the training module is further configured for:

training the generative adversarial network model by using the objective function to obtain generator parameters of the generator, first discriminator parameters of the first discriminator and second discriminator parameters of the second discriminator; and

inputting the generator parameters, the first discriminator parameters and the second discriminator parameters into the generative adversarial network model to obtain the generated countermeasure network model.

In some embodiments, the objective function is:

$${min}_{G} {max}_{{D}_{1} , {D}_{2}} V ( {D}_{1} , {D}_{2} , G ) \\ V ( {D}_{1} , {D}_{2} , G ) = {E}_{x ∼ {p}_{negData}} [ log {D}_{1} ( x ) ] + {E}_{Z ∼ {p}_{Z}} [ log {D}_{1} ( z ) ] + {E}_{x ∼ {p}_{posData}} [ log {D}_{2} ( x ) ] + {E}_{y ∼ {p}_{allData}} [ log ( 1 - {D}_{2} ( y ) ) ]$$

where, posData represents positive class data, negData represents negative class data, allData represents a union of generated negative class data and original negative class data, D₁ represents a first discriminator parameter, D₂ represents a second discriminator parameter, G represents a generator parameter.

In some embodiments, the structure of the first discriminator and the structure of the second discriminator are the same, the first discriminator includes a plurality of cascaded discriminant units and sigmoid layers, the output of the last discriminant unit serves as an input to the sigmoid layer, and each of the discriminant units includes cascaded fully connected layer, leaky-ReLU layer and sigmoid layer.

In some embodiments, the generator includes a plurality of cascaded generation units, each of the generation unit includes cascaded full-connection layers, normalization layers, and leaky-ReLU layers.

In a fourth aspect, the present application relates to an apparatus for data enhancement, including:

a generating module, configured for generating second negative sample data by using a generative adversarial network model, the generative adversarial network model is trained by using a method for model training according to the present application; and

an adding module, configured for adding the second negative sample data to an original data set to obtain a new data set, the original data set includes preset positive sample data and preset negative sample data.

In a fifth aspect, the present application relates to an electronic device, including: a processor, a communication interface, a memory and a communication bus, wherein the processor, the communication interface and the memory communicate with each other through the communication bus;

the memory is configured for storing computer programs; and

the processor is configured to implement the method for model training according to the present application or a method for data enhancement according to according to the present application, when executing a program stored in the memory.

In a sixth aspect, the present application relates to a computer-readable storage medium, where a program of a method for model training or a program of a method for data enhancement is stored on the computer-readable storage medium, where the program of the method for model training, when executed by a processor, implements the method for model training according to the present application, the program of the method for data enhancement, when executed by a processor, implements the method for data enhancement according to the present application.

In some embodiments, the reference sample data is generated by a generator, the first discriminator calculates a first distance between the reference sample data and the preset negative sample data, the second discriminator calculates a second distance between the negative class data and the preset positive sample data, where the negative class data is composed of the reference sample data and the preset negative sample data, then the objective function is determined based on the first distance and the second distance, and finally the generative adversarial network model can be trained by using the objective function until the generative adversarial network model converges to obtain the generative adversarial network model.

In some embodiments, the reference sample data is generated by a generator, the objective function is determined based on the first distance and the second distance, the generative adversarial network model is trained by using the objective function, so that the output data of the trained generative adversarial network model can satisfy a preset sample balance condition, and additional data is generated for the type of samples of a smaller quantity, i.e. the generated output data can make the two types of samples more balanced. Because the data is generated additionally, so it will not cause loss to the data quantity to make the data sample label unbalanced.

### BRIEF DESCRIPTION OF THE DRAWINGS

The accompanying drawings which are incorporated in and constitute a part of the specification illustrate embodiments consistent with the application and together with the description serve to explain the principles of the application.

In order to more clearly explain the technical solution of the present application, the drawings of the present application will be briefly introduced below, and it will be obvious that other drawings can be obtained from these drawings without creative labor for those of ordinary skill in the art.

FIG. 1 is a schematic diagram of the principle of a generative adversarial network model provided by an embodiment of the present application.

FIG. 2 is a flowchart of a method for model training provided by an embodiment of the present application.

FIG. 3 is a flowchart of step S105 in FIG. 1.

FIG. 4 is another flowchart of a method for model training provided by an embodiment of the present application.

FIG. 5 is a structural diagram of an apparatus for model training provided by an embodiment of the present application.

FIG. 6 is a structural diagram of another apparatus for model training provided by an embodiment of the present application.

FIG. 7 is a structural diagram of an electronic device provided by an embodiment of the present application.

### DETAILED DESCRIPTION OF THE EMBODIMENTS

In order to make the purposes, technical aspects and advantages of the disclosed embodiments clearer, the technical aspects of the disclosed embodiments will be clearly and completely described below in conjunction with the accompanying drawings in the disclosed embodiments, and it will be apparent that the described embodiments are part of, but not all of, the embodiments of the disclosed embodiments. Based on the embodiments in the present application all other embodiments obtained without creative effort by those of ordinary skill in the art fall within the scope of protection of the present application.

An embodiment of the application provides a method and an apparatus for model training and data enhancement, an electronic device and a storage medium. The method for model training is used for training a generative adversarial network. The generative adversarial network is a method of non-supervised learning in machine learning, and learning is carried out by making two neural networks play games with each other. The generative adversarial network consists of a generative network and a discriminant network. The generative adversarial network randomly samples from a latent space as input, and its output results need to imitate the real samples in the training set as much as possible. The inputs of the discriminant network are the real samples or the output of the generative adversarial network, the purpose of which is to distinguish the output of the generative adversarial network from the real samples as much as possible. The generation network should deceive the discriminant network as much as possible. The two networks confront each other and constantly adjust their parameters, the ultimate goal is to make the discriminant network unable to judge whether the output results of the generative adversarial network are true or not.

In some embodiments, both positive samples and negative samples are used simultaneously to generate negative sample data to train the generative adversarial network. Embodiments of the present application are based on the principle that the difference between the generated data and the negative sample is reduced and the difference between the generated data and the positive sample is increased. The negative samples generated by this method can keep close to the distribution of the real negative samples but keep enough separation interval from the positive samples. The reorganized data can make the classifier find the separation surface of positive and negative classes better.

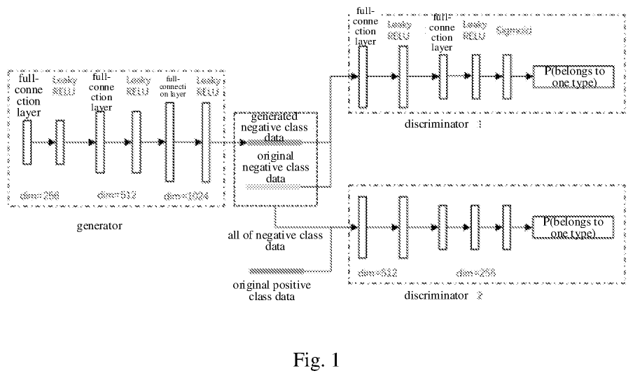

In some embodiments, as shown in FIG. 1, a generative adversarial network model includes a generator and two discriminators, that is, a method for model training is used to train the generator and two discriminators. The output of the generator is used as the input of the two discriminators, assuming that the two discriminators are respectively a first discriminator and a second discriminator, and the generator is configured to convert the input random noise data into data with similar distribution to the real negative sample, thereby generating reference sample data (negative sample data) to achieve the purpose of data enhancement.

Inputting the reference sample data and preset negative sample data into a first discriminator. The first discriminator discriminates a difference between the reference sample data and the preset negative sample data, i.e., the first discriminator is configured to judge whether the reference sample data and the preset negative sample data belong to the same class.

The reference sample data and the preset negative sample data are merged to obtain negative class data, and the negative class data and preset positive sample data are input to a second discriminator. The second discriminator discriminates a difference between the negative class data and the preset positive sample data, that is, the second discriminator is configured to judge whether the negative class data and the preset positive sample data belong to the same class.

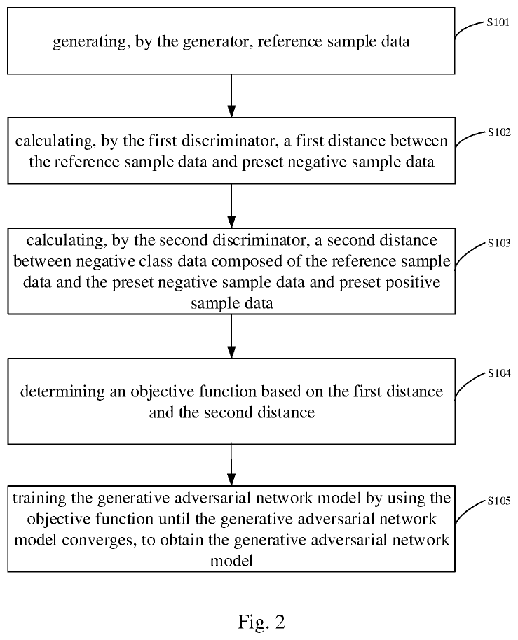

As shown in FIG. 2, the method for model training may include the following steps:
step S101, generating, by the generator, reference sample data;
step S102, calculating, by the first discriminator, a first distance between the reference sample data and preset negative sample data;
step S103, calculating, by the second discriminator, a second distance between negative class data composed of the reference sample data and the preset negative sample data and preset positive sample data;
step S104, determining an objective function based on the first distance and the second distance; and
step S105, training the generative adversarial network model by using the objective function until the generative adversarial network model converges, to obtain the generative adversarial network model.

In some embodiments, the generator includes a plurality of cascaded generation units. Each of the generation units includes cascaded full-connection layers, normalization layers and leaky-ReLU layers, where the normalization layer may refer to a batch-normalization algorithm layer. The batch-normalization algorithm layer is used for preventing gradient explosion. In some embodiments, the dimensions of both a full-connection layer and a leaky-ReLU layer in a first generation unit are 256, the dimensions of both a full-connection layer and a leaky-ReLU layer in a second generation unit are 512, and the dimensions of both a full-connection layer and a leaky-ReLU layer in a third generation unit are 1024.

Prior to step S101, an original data set and random noise data subject to a Gaussian distribution can be acquired. The original data set includes preset positive sample data and negative sample data.

In some embodiments, samples with fewer labels are referred to as negative sample data, samples with more labels are referred to as positive sample data. And let the label of a negative sample be −1, and let the label of positive samples be 1.

In some embodiments, random noise data subject to a Gaussian distribution may be input to an input layer of the generator. The dimensions of the random noise data is 100, and the generator may generate reference sample data based on the random noise data.

In some embodiments, the first discriminator includes a plurality of cascaded discriminant units and sigmoid layers, the output of a last discriminant unit being an input to the sigmoid layer. Each of the discriminant units includes cascaded fully connected layers and leaky-ReLU layers. The dimensions of both a fully connected layer and a leaky-ReLU layer in a first discriminant unit are 512. The dimensions of both a fully connected layer and a leaky-ReLU layer in a second discriminant unit are 256.

In some embodiments, the second discriminator has the same structure as the first discriminator. The second discriminator includes a plurality of cascaded discriminant units and sigmoid layers. The output of the last discriminant unit serves as an input to the sigmoid layer. Each of the discriminant units includes cascaded fully connected layers, leaky-ReLU layers and sigmoid layers.

In order to reduce the difference between the reference sample data and the negative sample, and to increase the difference between the reference sample data and the positive sample, that is, the embodiment of the present application is intended to enable the target sample data to cause a large error in the first classifier (i.e., to cause a small gap between the target sample data and the preset negative sample data) and to cause a small error in the second classifier (i.e., to cause a large gap between the target sample data and the preset positive sample data).

In some embodiments, an optimization objective of the objective function is to minimize the first distance and maximize the second distance.

Therefore, in this step, the target sample data satisfying a preset sample balance condition can be selected from the reference sample data based on the first distance and the second distance, and the preset sample balance condition can mean that the difference with the preset negative sample data is small and the difference with the preset positive sample data is large.

The target sample data satisfying the preset sample balance condition is, among the reference sample data, the target sample data of which the first distance is smaller and the second distance is larger. For example, the target sample data may refer to, among the reference sample data, the target sample data of which the first distance is smaller than the preset first threshold and the second distance is larger than the preset second threshold.

In some embodiments, the preset negative sample data and the positive sample data may be inputted into the generative adversarial network model, and model parameters of the generative adversarial network model are continuously adjusted based on the difference between the output data of the generative adversarial network model and the target sample data until the output data is consistent with the target sample data and the generative adversarial network model is determined to converge, to obtain the generative adversarial network model for data enhancement.

In an embodiment of the present application, the reference sample data is generated by a generator, the first discriminator calculates a first distance between the reference sample data and the preset negative sample data, the second discriminator calculates a second distance between the negative class data and the preset positive sample data, where the negative class data is composed of the reference sample data and the preset negative sample data, then the objective function is determined based on the first distance and the second distance, and finally the generative adversarial network model can be trained by using the objective function until the generative adversarial network model converges to obtain the generative adversarial network model.

In an embodiment of the present application, the reference sample data is generated by a generator, the objective function is determined based on the first distance and the second distance, the generative adversarial network model is trained by using the objective function, so that the output data of the trained generative adversarial network model can satisfy a preset sample balance condition, and additional data is generated for the type of samples of a smaller quantity, i.e. the generated output data can make the two types of samples more balanced. Because the data is generated additionally, so it will not cause loss to the data quantity to make the data sample label unbalanced.

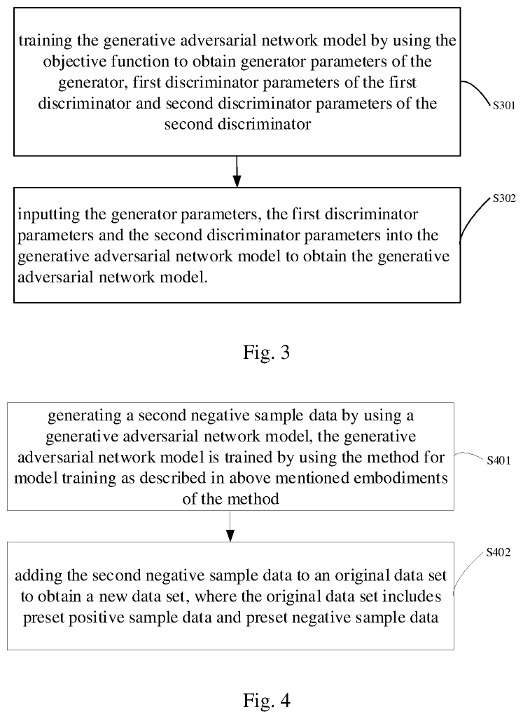

In some embodiments, as shown in FIG. 3, step S105 may include the following steps:
step S301, training the generative adversarial network model by using the objective function to obtain generator parameters of the generator, where first discriminator parameters of the first discriminator and second discriminator parameters of the second discriminator; and
step S302, inputting the generator parameters, the first discriminator parameters and the second discriminator parameters into the generative adversarial network model to obtain the generative adversarial network model.

In some embodiments, the objective function is:

$${min}_{G} {max}_{{D}_{1} , {D}_{2}} V ( {D}_{1} , {D}_{2} , G ) \\ V ( {D}_{1} , {D}_{2} , G ) = {E}_{x ∼ {p}_{negData}} [ log {D}_{1} ( x ) ] + {E}_{Z ∼ {p}_{Z}} [ log {D}_{1} ( z ) ] + {E}_{x ∼ {p}_{posData}} [ log {D}_{2} ( x ) ] + {E}_{y ∼ {p}_{allData}} [ log ( 1 - {D}_{2} ( y ) ) ]$$

where, posData represents positive class data, negData represents negative class data, and allData represents a union of generated negative class data and original negative class data. D₁ represents a first discriminator parameter, D₂ represents a second discriminator parameter, G represents a generator parameter.

In an embodiment of the present application, the model parameters can be continuously adjusted by using the objective function, and finally to obtain the generator parameters, the first discriminator parameters and the second discriminator parameters, which is convenient to make the output data of the generative adversarial network model satisfy the preset sample balance condition. Additional data is generated for the type of samples of a smaller quantity, i.e., the generated output data can make the two types of samples more balanced. Because the data is generated additionally, so it will not cause loss to the data quantity to make the data sample label unbalanced.

The present application also relates to a method for data enhancement method, as shown in FIG. 4, the method includes:
step S401, generating a second negative sample data by using a generative adversarial network model, the generative adversarial network model is trained by using the method for model training as described in above mentioned embodiments of the method; and
step S402, adding the second negative sample data to an original data set to obtain a new data set, where the original data set includes preset positive sample data and preset negative sample data.

In some embodiments, the input data for a generative adversarial network is random noise data subject to a Gaussian distribution, and when data enhancement is performed using the generative adversarial network model, the input data for the generative adversarial network model is the same as the random noise data subject to a Gaussian distribution input to the generator when the generative adversarial network model is trained.

The total amount of the second negative sample data plus the preset negative sample data should generally be the same as the amount of the preset positive sample data.

After the second negative sample data is generated, the data label corresponding to the second negative sample data is set to −1 (i.e., the same as the label of the preset negative sample data).

In some embodiments, the generated second negative sample data may be added to the original data set, and the entire data set may be randomly scrambled to obtain a new data set.

In an embodiment of the application, the second negative sample data can be generated, and the second negative sample data generated can be added to the original data set to obtain a new data set which can be directly used for training, and the new data set has no dependency on the model used by the new data set.

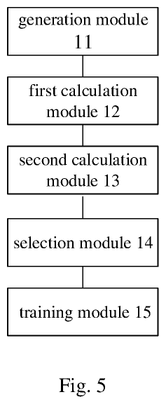

The present application also relates to an apparatus for model training, a generative adversarial network model includes a generator and two discriminators, an output of the generator is used as an input of the two discriminators, as shown in FIG. 5, the apparatus includes:

a generation module 11, configured for generating, by the generator, reference sample data;

a first calculation module 12, configured for calculating, by the first discriminator, a first distance between the reference sample data and preset negative sample data;

a second calculation module 13, configured for calculating, by the second discriminator, a second distance between negative class data composed of the reference sample data and the preset negative sample data and preset positive sample data;

a selection module 14, configured for determining an objective function based on the first distance and the second distance; and

a training module 15, configured for training the generative adversarial network model by using the objective function until the generative adversarial network model converges, to obtain the generative adversarial network model.

In some embodiments, an optimization objective of the objective function is to minimize the first distance and maximize the second distance.

In some embodiments, the training module is further configured for:

training the generative adversarial network model by using the objective function to obtain generator parameters of the generator, first discriminator parameters of the first discriminator and second discriminator parameters of the second discriminator; and

inputting the generator parameters, the first discriminator parameters and the second discriminator parameters into the generative adversarial network model to obtain the generated countermeasure network model.

In some embodiments, the objective function is:

$${min}_{G} {max}_{{D}_{1} , {D}_{2}} V ( {D}_{1} , {D}_{2} , G ) \\ V ( {D}_{1} , {D}_{2} , G ) = {E}_{x ∼ {p}_{negData}} [ log {D}_{1} ( x ) ] + {E}_{Z ∼ {p}_{Z}} [ log {D}_{1} ( z ) ] + {E}_{x ∼ {p}_{posData}} [ log {D}_{2} ( x ) ] + {E}_{y ∼ {p}_{allData}} [ log ( 1 - {D}_{2} ( y ) ) ]$$

where, posData represents positive class data, negData represents negative class data, allData represents a union of generated negative class data and original negative class data, D₁ represents a first discriminator parameter, D₂ represents a second discriminator parameter, G represents a generator parameter.

In some embodiments, the structure of the first discriminator and the structure of the second discriminator are the same, the first discriminator comprises a plurality of cascaded discriminant units and sigmoid layers, the output of the last discriminant unit serves as an input to the sigmoid layer, and each of the discriminant units comprises cascaded fully connected layer, leaky-ReLU layer and sigmoid layer.

In certain embodiments, the generator comprises a plurality of cascaded generation units, each of the generation unit comprises cascaded full-connection layers, normalization layers, and leaky-ReLU layers.

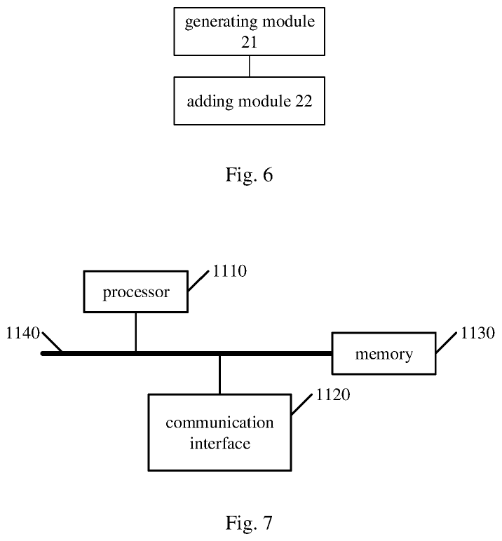

The present application also relates to an apparatus for data enhancement, as shown in FIG. 6, including:

a generating module 21, configured for generating second negative sample data by using a generative adversarial network model, wherein, the generative adversarial network model is trained by using a method for model training according to claim 1; and

an adding module 22, configured for adding the second negative sample data to an original data set to obtain a new data set, wherein, the original data set comprises preset positive sample data and preset negative sample data.

The application also relates to an electronic device, comprising a processor, a communication interface, a memory and a communication bus, wherein the processor, the communication interface and the memory communicate with each other through the communication bus;

the memory is configured for storing computer programs;

the processor is configured to implement the method a method for model training as described in above mentioned embodiments of the method or a method for data enhancement as described in above mentioned embodiments of the method, when executing a program stored in the memory.

In the electronic device provided by the embodiment of the application, the processor, by executing the program stored in the memory, realizes that in an embodiment of the present application, the reference sample data is generated by a generator, the first discriminator calculates a first distance between the reference sample data and the preset negative sample data, the second discriminator calculates a second distance between the negative class data and the preset positive sample data, where the negative class data is composed of the reference sample data and the preset negative sample data, then the objective function is determined based on the first distance and the second distance, and finally the generative adversarial network model can be trained by using the objective function until the generative adversarial network model converges to obtain the generative adversarial network model. In an embodiment of the present application, the reference sample data is generated by a generator, the objective function is determined based on the first distance and the second distance, the generative adversarial network model is trained by using the objective function, so that the output data of the trained generative adversarial network model can satisfy a preset sample balance condition, and additional data is generated for the type of samples of a smaller quantity, i.e. the generated output data can make the two types of samples more balanced. Because the data is generated additionally, so it will not cause loss to the data quantity to make the data sample label unbalanced.

The communication bus 1140 mentioned in the above-mentioned electronic device may be a Peripheral Component Interconnect (PCI) bus or an Extended Industry Standard Architecture (EISA) bus or the like. The communication bus 1140 may be divided into an address bus, a data bus, a control bus and the like. For ease of presentation, only one thick line is used in FIG. 7, but it does not mean that there is only one bus or one type of bus.

The communication interface 1120 is configured for communication between the above-mentioned electronic device and other devices.

The memory 1130 may include a Random Access Memory (RAM) or a non-volatile memory such as at least one disk memory. In some embodiments, the memory may also be at least one storage device located remotely from the processor.

The processor 1110 may be a general-purpose processor, including a Central Processing Unit (CPU), a Network Processor (NP), and the like. It can also be a Digital Signal Processing (DSP), an Application Specific Integrated Circuit (ASIC), a Field-Programmable Gate Array (FPGA) or other programmable logic devices, discrete gates or transistor logic devices, and discrete hardware components.

The present application also provides a computer-readable storage medium, where a program of a method for model training or a program of a method for data enhancement is stored on the computer-readable storage medium, where the program of the method for model training, when executed by a processor, implements steps of the method for model training according to the present application, the program of the method for data enhancement, when executed by a processor, implements steps of the method for data enhancement according to the present application.

It should be noted that relational terms such as “first” and “second” are used herein only to distinguish one entity or operation from another, and do not necessarily require or imply any such actual relationship or order between these entities or operations. Moreover, the terms “including”, “including” or any other variation thereof are intended to encompass non-exclusive inclusion, so that a process, method, article or equipment that includes a set of elements includes not only those elements but also other elements that are not explicitly listed or are inherent to such a process, method, article or equipment. In the absence of further limitations, an element defined by the phrase “includes an . . . ” does not preclude the existence of another identical element in the process, method, article or equipment in which the element is included.

The foregoing is only a specific embodiment of the present application to enable those skilled in the art to understand or implement the present application. Various modifications to these embodiments will be apparent to those skilled in the art and the general principles defined herein may be implemented in other embodiments without departing from the spirit or scope of the present application. Accordingly, the present application will not be limited to the embodiments shown herein but is intended to conform to the widest scope consistent with the principles and novel features disclosed herein.

1. A method for model training, wherein a generative adversarial network model comprises a generator and two discriminators, an output of the generator is used as an input of the two discriminators, the method comprising:
generating, by the generator, reference sample data;
calculating, by the first discriminator, a first distance between the reference sample data and preset negative sample data;
calculating, by the second discriminator, a second distance between negative class data composed of the reference sample data and the preset negative sample data and preset positive sample data;
determining an objective function based on the first distance and the second distance; and
training the generative adversarial network model by using the objective function until the generative adversarial network model converges, to obtain the generative adversarial network model.

2. The method for model training according to claim 1, wherein an optimization objective of the objective function is to minimize the first distance and maximize the second distance.

3. The method for model training according to claim 1, wherein training the generative adversarial network model by using the objective function until the generative adversarial network model converges, to obtain the generative adversarial network model comprises:
training the generative adversarial network model by using the objective function to obtain generator parameters of the generator, first discriminator parameters of the first discriminator and second discriminator parameters of the second discriminator; and
inputting the generator parameters, the first discriminator parameters and the second discriminator parameters into the generative adversarial network model to obtain the generated countermeasure network model.

4. The method for model training according to claim 3, wherein the objective function is:
$${min}_{G} {max}_{{D}_{1} , {D}_{2}} V ( {D}_{1} , {D}_{2} , G ) \\ V ( {D}_{1} , {D}_{2} , G ) = {E}_{x ∼ {p}_{negData}} [ log {D}_{1} ( x ) ] + {E}_{Z ∼ {p}_{Z}} [ log {D}_{1} ( z ) ] + {E}_{x ∼ {p}_{posData}} [ log {D}_{2} ( x ) ] + {E}_{y ∼ {p}_{allData}} [ log ( 1 - {D}_{2} ( y ) ) ]$$
wherein, posData represents positive class data, negData represents negative class data, allData represents a union of generated negative class data and original negative class data, D₁ represents a first discriminator parameter, D₂ represents a second discriminator parameter, G represents a generator parameter.

5. The method for model training according to claim 1, wherein the structure of the first discriminator and the structure of the second discriminator are the same, the first discriminator comprises a plurality of cascaded discriminant units and sigmoid layers, the output of the last discriminant unit serves as an input to the sigmoid layer, and each of the discriminant units comprises cascaded fully connected layer, leaky-ReLU layer and sigmoid layer.

6. The method for model training according to claim 1, wherein the generator comprises a plurality of cascaded generation units, each of the generation unit comprises cascaded full-connection layers, normalization layers, and leaky-ReLU layers.

7. A method for data enhancement, comprising:
generating second negative sample data by using a generative adversarial network model, wherein the generative adversarial network model is trained by using a method for model training according to claim 1; and
adding the second negative sample data to an original data set to obtain a new data set, wherein the original data set comprises preset positive sample data and preset negative sample data.

8. An apparatus for model training, wherein, a generative adversarial network model comprises a generator and two discriminators, an output of the generator is used as an input of the two discriminators, the apparatus comprises:
a generation module, configured for generating, by the generator, reference sample data;
a first calculation module, configured for calculating, by the first discriminator, a first distance between the reference sample data and preset negative sample data;
a second calculation module, configured for calculating, by the second discriminator, a second distance between negative class data composed of the reference sample data and the preset negative sample data and preset positive sample data;
a selection module, configured for determining an objective function based on the first distance and the second distance; and
a training module, configured for training the generative adversarial network model by using the objective function until the generative adversarial network model converges, to obtain the generative adversarial network model.

9. An apparatus for data enhancement, comprising:
a generating module, configured for generating second negative sample data by using a generative adversarial network model, wherein the generative adversarial network model is trained by using a method for model training according to claim 1; and
an adding module, configured for adding the second negative sample data to an original data set to obtain a new data set, wherein the original data set comprises preset positive sample data and preset negative sample data.

10. An electronic device, comprising: a processor, a communication interface, a memory and a communication bus, wherein the processor, the communication interface and the memory communicate with each other through the communication bus;
the memory is configured for storing computer programs; and
the processor is configured to implement a method for model training according to claim 1, when executing a program stored in the memory.

11. A non-transitory computer-readable storage medium, wherein a program of a method for model training is stored on the non-transitory computer-readable storage medium, wherein, the program of the method for model training, when executed by a processor, implements the method for model training according to claim 1.

12. An electronic device, comprising: a processor, a communication interface, a memory and a communication bus, wherein the processor, the communication interface and the memory communicate with each other through the communication bus;
the memory is configured for storing computer programs; and
the processor is configured to implement a method for data enhancement according to claim 7, when executing a program stored in the memory.

13. A non-transitory computer-readable storage medium, wherein a program of a method for data enhancement is stored on the non-transitory computer-readable storage medium, wherein, the program of the method for data enhancement, when executed by a processor, implements the method for data enhancement according to claim 7.
